(19) United States
(12) Patent Application Publication
(10) Pub. No.: US 2026/0321070 A1
(43) Pub. Date: Oct. 15, 2026

(54) MOTOR VEHICLE AND METHOD FOR FEEDBACK OF DRIVING BEHAVIOR BY AN AVATAR IN A MOTOR VEHICLE

(71) Applicant: AUDI AG, Ingolstadt (DE)

(72) Inventors: Matthias Pfromm, Ingolstadt (DE); Andreas Sebastian Binder, Hepberg (DE); Moritz Neubauer, Krautheim (DE)

(73) Assignee: AUDI AG, Ingolstadt (DE)

(21) Appl. No.: 19/174,453

(22) Filed: Apr. 9, 2025

(30) Foreign Application Priority Data
Apr. 11, 2024 (DE) 10 2024 110 153.9

(51) Int. Cl. G07C 5/06

(52) U.S. Cl. CPC G07C 5/06

(57) ABSTRACT

A motor vehicle and a method for feedback of a driving behavior by an avatar in the motor vehicle. The method includes measuring driving data by a sensor device of the motor vehicle; an evaluation of a driving behavior on the basis of the measured driving data by a computing device of the motor vehicle, wherein a reaction of the avatar is determined on the basis of the evaluation of the driving behavior. The method includes control of the avatar with the determined reaction, wherein the reaction is carried out by the avatar as a body movement, which includes at least one gesture of the avatar.

### CROSS REFERENCE TO RELATED APPLICATIONS

This application is based upon and claims the priority benefit of German Application No. 10 2024 110 153.9 filed on Apr. 11, 2024, the entire contents of which are incorporated by reference herein.

### BACKGROUND

### Field

Disclosed herein is a method for feedback of driving behavior by an avatar in a motor vehicle. Furthermore, the disclosure relates to a motor vehicle which is designed to carry out the method.

### Description of the Related Art

Many car manufacturers now use avatars to communicate between a user and the vehicle, for example to set vehicle functions. For example, windows can be lowered or radio stations can be tuned to.

There are also applications for evaluating driving behavior based on acceleration data in order to evaluate the driver's driving style, for example for insurance classifications. In particular, safety and comfort can be increased by even, continuous steering in a bend and an appropriate (cornering) speed. Gentle braking can make better use of the recuperation of electric vehicles and thus save energy. Gentle acceleration can increase the comfort of the passengers and reduce wear and consumption of the vehicle.

From US 2003/0060937 A1, an in-vehicle device, a vehicle and a method for processing vehicle information are known, which are used, for example, to assist in driving a motor vehicle and can correctly communicate a driving situation to a driver. Here, the user's interaction with the vehicle is expressed through virtual feelings, wherein it is assumed that the vehicle has a personality and indicates virtual feelings through facial expressions of a predetermined character.

An information processing device is known from US 2021/0291841 A1 that has a controller configured to capture information about a driving behavior as an indication of a driver's caution when driving a vehicle, to capture a vehicle avatar corresponding to the vehicle, wherein the vehicle avatar has a basic personality assigned to it according to the information about the vehicle, to generate a message according to the basic personality of the vehicle avatar based on the information about the driving behavior and to output the generated message as a statement of the vehicle avatar.

A three-dimensional physical figure for communication with an occupant in a motor vehicle is known from DE 10 2010 053 394 A1, wherein the three-dimensional physical figure can be locked in the motor vehicle. In particular, it is envisaged that a communication from an occupant or driver of the motor vehicle to the three-dimensional physical figure takes place acoustically and/or haptically, and that communication from the three-dimensional physical figure to a driver or an occupant of the motor vehicle takes place visually and/or acoustically.

### SUMMARY

An aspect of the invention is directed to feature(s) to influence a driver's driving behavior and thus increase safety and/or minimize wear.

One aspect of the invention relates to a method for feedback of driving behavior by an avatar in a motor vehicle. The method includes as steps a measurement of driving data by a sensor device of the motor vehicle, an evaluation of a driving behavior on the basis of the measured driving data by a computing device of the motor vehicle, wherein a reaction of the avatar is determined on the basis of the evaluation of the driving behavior, and control of the avatar with the determined reaction, wherein the reaction is carried out by the avatar as a body movement that includes at least one gesture of the avatar.

In other words, driving data of the motor vehicle can be determined first, in particular by means of a sensor device that includes, for example, speed sensors, acceleration sensors and/or angle of rotation sensors. These driving data may then be analyzed by a computing device of the motor vehicle, in particular by a computer program running on the computing device, in order to evaluate the driving behavior of a user. For example, the driving data can be compared with predetermined limit values or characteristic curves to determine whether the driving behavior or a driving maneuver is within a normal range or not. Depending on this, the reaction of the avatar can be determined, which is to be output as a reaction to the driving behavior. The avatar can be a digital or physical representation of the motor vehicle, and is represented for example on a display device or by means of a hardware component.

Finally, the avatar can be controlled with the determined reaction, wherein the reaction is carried out as a body movement by the avatar, which includes at least one gesture. This means that the reaction is displayed as a movement of the avatar's body, for example by turning the head during steering movements or by tilting the body during acceleration, wherein the avatar can tip over in the corresponding direction if predetermined limit values are exceeded, for example. For example, during steering the avatar can turn its head in response, although if the driver steers unevenly or jerkily, the avatar can become dizzy. During acceleration, the avatar can lean in the opposite direction to the acceleration, wherein the avatar can fall over if the acceleration is too strong or jerky. This also applies, for example, during braking or cornering. At increased speeds, for example, the avatar may take on an anxious facial expression.

These avatar reactions can preferably be carried out in real time to provide the driver with direct feedback on the driving behavior. Furthermore, however, a global rating can also be formed, which can be used to represent a sentiment and a bonus rating, for example. Alternatively or additionally, facial expressions can also be changed as a reaction. For example, at increased speeds, an anxious facial expression can be assumed by the avatar and, if the driver shows a desired behavior over a period of time, the avatar can develop a good mood. Preferably, rewards can be unlocked, such as different avatar appearances, to further influence driving behavior. However, if the driver does not show the desired driving behavior over a period of time, the avatar can develop a bad mood.

The reaction of the avatar gives the driver prompt feedback on the driving behavior, wherein he can adjust this based on the reaction. In particular, it can be achieved that driving behavior is improved, which improves safety when driving the motor vehicle and/or reduces wear and tear on the motor vehicle.

The invention also includes embodiments that result in additional advantages.

One design provides that the driving data include positive and/or negative acceleration, a rotation of the steering wheel, a pedal operation and/or jerking. Jerking refers to temporal rates of change in acceleration. These driving data can provide the most important parameters for evaluating driving behavior to determine the reaction of the avatar.

Another design provides that the reaction of the avatar is carried out in real time. Real-time means that a current driving behavior is displayed directly by the reaction of the avatar, wherein a processing time of the driving data can be available as a tolerance. Differentiating from direct feedback in real time is an averaged evaluation of a longer period of driving behavior. This design has the advantage that the driver receives direct feedback on each driving maneuver carried out and can thus adapt the driving behavior better.

Another design provides for the measured driving data to be compared with predetermined characteristic curves to evaluate driving behavior. For example, there may be characteristic curves for a target acceleration or target deceleration and/or a target steering angle. The reaction of the avatar can then be calculated according to a target/actual comparison between the current vehicle data and the stored characteristic curves. Preferably, position data of the motor vehicle and map data can also be taken into account in the evaluation, for example how tight a bend is and which characteristic curves are to be used for this bend. This allows a simple evaluation of the driving data to be achieved.

Another embodiment provides for the measured driving data to be evaluated by a pre-trained AI model to evaluate driving behavior. An AI model refers to artificial intelligence learned through machine learning, such as a neural network, which can evaluate the driving data for evaluation of the driving behavior. The AI model can be taught, for example, by driving data from trips made by other vehicles in which the driving behavior has been evaluated. This learning data can be provided, for example, through supervised learning.

Another design provides for the avatar to be displayed on a display device of the motor vehicle, in particular a screen, a head-up display and/or augmented reality glasses. This means that the avatar can be in digital form and displayed on a display device.

Another design provides that the avatar is provided as a hardware component that represents the reaction physically. That is, the avatar can be provided as a physical device in the motor vehicle that can be controlled electromechanically to carry out the reactions as a body movement.

Another design provides that the avatar turns its head in response to steering and becomes dizzy in the event of jerky steering. This means that it can be indicated, especially during steering movements, whether the steering is within a normal range or too strong.

Another design is that the avatar leans against the direction of acceleration in response to acceleration and falls over in the event of acceleration that is too strong. Acceleration refers to positive and negative accelerations, including braking, for example. Furthermore, the avatar can also lean or fall over in the corresponding direction when taking a bend.

A further aspect of the invention relates to a motor vehicle, containing at least a sensor device, a computing device and an avatar, wherein the motor vehicle is designed to carry out a method according to the preceding aspect. This results in the same advantages and variation possibilities as with the method. In particular, the motor vehicle according to the invention is preferably in the form of a passenger car or truck, or of a passenger bus or motorcycle.

For use cases or application situations that may arise with the method and that are not explicitly described here, it may be provided that an error message and/or a request for user feedback is issued in accordance with the method and/or a default setting and/or a predetermined initial state is set.

The invention, according to an aspect, also includes the control device for the motor vehicle. The control device may have a data-processing device or a processor device that is set up to carry out an embodiment of the method according to the invention. For this purpose, the processor device may have at least one microprocessor and/or at least one microcontroller and/or at least one FPGA (Field Programmable Gate Array) and/or at least one DSP (Digital Signal Processor). In particular, a CPU (Central Processing Unit), a GPU (Graphical Processing Unit) or an NPU (Neural Processing Unit) can be used as a microprocessor. Furthermore, the processor device may contain program code which is set up to carry out the embodiment of the method according to the invention when executed by the processor device. The program code can be stored in a data memory of the processor device. The processor device can be based on at least one circuit board and/or at least one SoC (System on Chip), for example.

The invention, according to an aspect, also includes developments of the motor vehicle according to the invention which have features as have already been described in connection with the developments of the method according to the invention. For this reason, the corresponding developments of the motor vehicle according to the invention are not described again here.

As a further solution, the invention, according to an aspect, also includes a computer-readable memory medium, containing program code which, when executed by a computer or a computer network, causes it to carry out an embodiment of the method according to the invention. The memory medium can be provided at least partly as a non-volatile data memory (for example as a flash memory and/or as an SSD – solid state drive) and/or at least partly as a volatile data memory (for example as a RAM – random access memory). The memory medium can be located in the computer or computer network. However, the memory medium can also be operated as a so-called appstore server and/or cloud server on the Internet, for example. The computer or computer network can provide a processor circuit with, for example, at least one microprocessor. The program code can be provided as binary code and/or as assembly code and/or as source code of a programming language (for example C) and/or as a program script (for example Python).

The invention also includes the combinations of the features of the embodiments described. Thus, the invention also includes realizations, each of which has a combination of the features of several of the embodiments described, provided that the embodiments have not been described as mutually exclusive.

### BRIEF DESCRIPTION OF THE DRAWINGS

These and other aspects and advantages will become more apparent and more readily appreciated from the following description of the exemplary embodiments, taken in conjunction with the accompanying drawings. Exemplary embodiments of the invention are described below. In the figures:

FIG. 1 shows a motor vehicle according to an exemplary embodiment;

FIG. 2 shows exemplary reactions of the avatar according to an exemplary embodiment;

FIG. 3 shows a schematic process diagram according to an exemplary embodiment.

### DETAILED DESCRIPTION

Reference will now be made in detail to the preferred embodiments, examples of which are illustrated in the accompanying drawings, wherein like reference numerals refer to like elements throughout.

The embodiments explained below are preferred embodiments of the invention. In the case of the embodiments, the described components of the embodiments each represent individual features of the invention that are to be considered mutually independent, which also develop the invention independently of each other. Therefore, the disclosure is also intended to cover combinations of the features of the embodiments other than those presented. Furthermore, the embodiments described can also be supplemented by other features of the invention that have already been described.

In the figures, the same reference signs denote functionally identical elements.

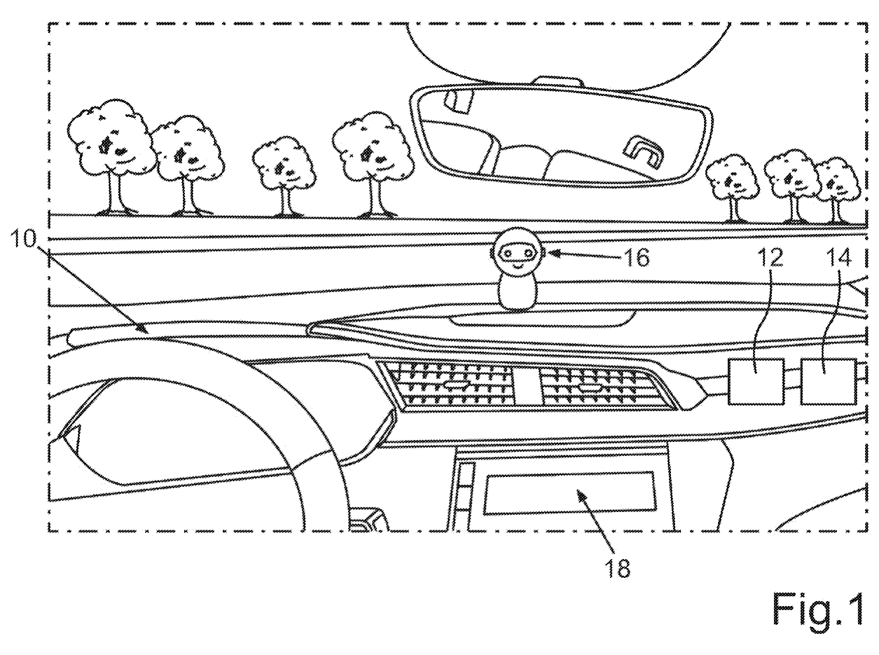

FIG. 1 shows a perspective from a motor vehicle 10 according to an exemplary embodiment, wherein the motor vehicle 10 may be designed to represent a driving behavior by an avatar. For this purpose, the motor vehicle 10 can comprise a sensor device 12, a computing device 14 and an avatar 16.

The sensor device 12 can be designed to measure driving data of the motor vehicle 10. For example, the sensor device 12 can determine positive and/or negative accelerations, a rotation of the steering wheel, a pedal actuation and/or jerking of the motor vehicle 10.

The computing device 14, which can be provided as a vehicle computer, for example, can be designed to evaluate the measured driving data and thus evaluate a driving behavior. For example, the driving data can be compared with predetermined characteristic curves in order to evaluate the driving behavior. Target accelerations and/or target steering angles can be compared with the respective actual values in order to check whether a driving maneuver is within a desired framework or not. Alternatively, this evaluation can also be carried out by a trained AI model. Based on this evaluation, the computing device can generate a control signal by means of which the avatar 16 can be controlled to carry out a reaction.

The avatar 16 can be a virtual or physical representation of the motor vehicle 10 and can convey the evaluation of the driving behavior through its reactions. For example, the avatar 16 can be a hardware component in the motor vehicle 10 that can be controlled by the computing device 14. Alternatively, the avatar 16 can be displayed on a display device 18 of the motor vehicle 10, such as a vehicle screen, augmented reality or a head-up display of the motor vehicle 10.

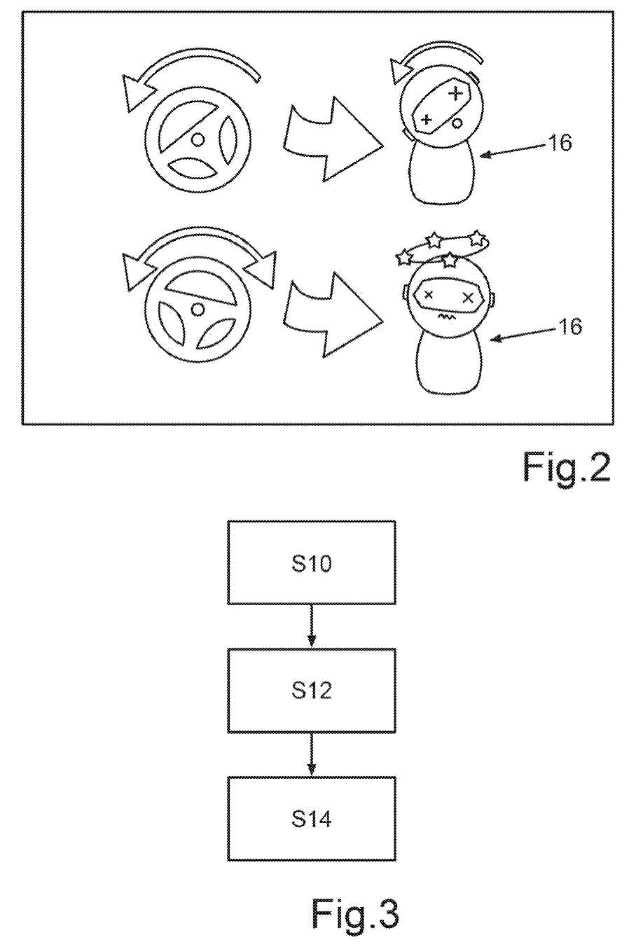

Depending on the reaction determined, the avatar 16 can then carry out a body movement that includes at least one gesture to indicate the driving behavior. Examples of this are shown in FIG. 2. For example, during a normal steering process, the avatar can turn its head according to the steering movement, wherein the avatar can become dizzy if the steering movements are too strong or jerky. Furthermore, the avatar 16 can, for example, lean against the direction of acceleration during acceleration which can also include braking and cornering, and can fall over if the acceleration is too strong. Thus, the driver preferably receives feedback in real time as to whether their driving behavior is appropriate or not. In particular, the avatar 16 can express the reaction to the driving behavior and thus reflect the mood. This allows the avatar 16 to express direct feedback on the driver's driving behavior through the behavior of the avatar and can contribute to an improved driving style, for example improved driving comfort or reduced energy consumption, as well as to increased safety in road traffic or can make the driver aware of their driving behavior.

FIG. 3 shows a schematic process diagram for feedback of driving behavior by an avatar 16 in a motor vehicle 10.

In operation S10, driving data can be measured by a sensor device 12 of the motor vehicle 10.

In operation S12, the driving behavior can be evaluated on the basis of the measured driving data by a computing device 14, wherein a reaction of the avatar 16 can be determined on the basis of the evaluation of the driving behavior. The evaluation of the driving behavior can be carried out, for example, by a pre-trained AI model.

Finally, in operation S14, the avatar 16 can be controlled with the determined reaction, wherein the reaction is carried out as a body movement, for example turning the head or tilting in a direction or the avatar 16 falling over.

Overall, the examples show how feedback of driving behavior can be carried out by an avatar 16.

A description has been provided with particular reference to preferred embodiments thereof and examples, but it will be understood that variations and modifications can be effected within the spirit and scope of the claims which may include the phrase "at least one of A, B and C" as an alternative expression that means one or more of A, B and C may be used, contrary to the holding in Superguide v. DIRECTV, 358 F3d 870, 69 USPQ2d 1865 (Fed. Cir. 2004).

1. A method for feedback of a driving behavior by an avatar in a motor vehicle, comprising:
measuring driving data by a sensor device of the motor vehicle;
evaluating a driving behavior based on the measured driving data by a computing device of the motor vehicle, wherein a reaction of the avatar is determined based on the evaluation of the driving behavior; and
controlling the avatar with the determined reaction, wherein the reaction is carried out by the avatar as a body movement, which includes at least one gesture of the avatar.

2. The method according to claim 1, wherein the driving data comprises a positive and/or negative acceleration, a rotation of a steering wheel, a pedal actuation, and/or jerking.

3. The method according to claim 1, wherein the reaction of the avatar is carried out in real time.

4. The method according to claim 1, wherein the measured driving data is compared with predetermined characteristic curves for the evaluating of the driving behavior.

5. The method according to claim 1, wherein the measured driving data is evaluated by a pre-trained AI model for the evaluating of the driving behavior.

6. The method according to claim 1, wherein the avatar is displayed on a display device of the motor vehicle a screen, a heads-up display (HUD) and/or an augmented reality (AR) glass.

7. The method according to claim 1, wherein the avatar is provided as a hardware component that physically represents the reaction.

8. The method according to claim 7, wherein the reaction includes a head turn by the avatar based on steering and/or represents dizziness when jerky steering occurs.

9. The method according to claim 7, wherein the avatar leans against a direction of acceleration based on acceleration of the motor vehicle and falls over in an event the acceleration exceeds a predetermined value.

10. A motor vehicle containing the sensor device the computing device the avatar, wherein the motor vehicle is designed to carry out the method for the feedback of the driving behavior by the avatar according to claim 1.
